(19) United States
(12) Patent Application Publication
(10) Pub. No.: US 2004/0172562 A1
(43) Pub. Date: Sep. 2, 2004

(54) System and method for identity recognition of an individual for enabling an access to a secured system

(76) Inventors: Vladimir Berger, Hayward, CA (US); Sergey Sapronov, San Mateo, CA (US)

Correspondence Address: VLADIMIR BERGER, 2237 Parnassus Court, Hayward, CA, 94542, US

(21) Appl. No.: 10/378,408

(22) Filed: Mar. 1, 2003

(51) Int. Cl. H04L 9/32

(52) U.S. Cl. 713/202

(57) ABSTRACT

A system and method of the invention for identity recognition based on the code input pattern are highly secure and simple. The system and the method prevent unauthorized access to a secured system by assuming that prior to the identification there should be a validation process. During the validation process a user inputs one or more times the patterns of the code or password entry, and the system measures and stores parameters of the input pattern that are unique to each user (for example, time delay between inputs of the adjacent symbols, time of holding each key depressed or other specific series of activities). These parameters form the user identity data validation pattern. When the user actually requests access to the secured system and submits the entry code, these parameters are measured again and compared against the previously stored data validation pattern to validate the identity of the user. The access to the secured system is granted or denied depending on the result of this comparison.

### FIELD OF INVENTION

The invention relates to secure systems, in particular to a system and method for verifying the identity of a user of a secured system to prevent unauthorized penetration into such systems as computers, communication and data-processing systems, on-line services, automated transaction mechanisms, banking systems, alarm systems of houses, safes, and the like.

### BACKGROUND OF THE INVENTION

The most common method of providing security is through the use of usernames and passwords or pins (personal identification numbers) as a means of identifying users of a secured system. These systems generally require knowledge of an entry code (or access code) that has been selected by a user or has been confirmed in advance. Code entry systems are known to suffer from some disadvantages. A user usually specifies entry codes, and most users choose entry codes that are relatively insecure. As a result, an access to many code entry systems can be gained through a simple trial and error process. There is also a chance of this code being stolen.

Another group of a personal identity or secure access/recognition systems with more secure access is described in U.S. Pat. No. 6,134,657 issued to Johnson et al. in 2000. This patent discloses a method and system for validating access to a computer system in an unobtrusive manner. A finite ordered series of substantive activities, such as icon manipulations, application invocations or file manipulations is specified and stored for future reference. Thereafter, each time access to the computer system is attempted, the initial activities of a prospective user are identified and compared to the stored finite ordered series of substantive activities. Access is validated, and continued access is permitted in response to a match between the prospective user's initial activities and the stored finite ordered series of substantive activities. In this manner, access to a computer system may be validated without the necessity of utilizing an explicit access/password screen, which may be compromised. One of the selected applications described in this patent may be automatically invoked or a particular activity automatically executed in response to a validation of access.

This type of secure access/authentication systems and methods has at least the following disadvantages: a) the long identification process for user's getting access to a secured environment, b) the system requires frequent support by a network administrator.

U.S. Pat. No. 4,723,284 issued to Munck et al. in 1988 discloses the hardware authentication system for a public key communications network. The public key network includes at least one user terminal and at least one hardware authentication terminal coupled by a communications medium. The authentication terminal generates and stores a plaintext message M, and generates from this message M a cipher-text message C by transforming the plaintext message M with the public key of the user terminal. The authentication terminal is further adapted to transmit the cipher-text message C by way of the medium to the user terminal. The user terminal is adapted to receive the enciphered or cipher-text message C from the hardware authentication terminal, and transform that cipher-text message with its private key to obtain a plaintext message M′. The user terminal is further adapted to transmit the plaintext message M′ by way of the medium to the authentication terminal. The authentication terminal also is adapted to receive the plaintext message M′ from the user terminal and compare that received plaintext message M′ with the stored plaintext message M. Upon identifying that the messages M and M′ match, the authentication terminal generates an authentic user signal indicating that the user terminal is the hardware terminal associated with the public key. In some forms of the system, the authentication terminal also, or alternatively, may authenticate whether or not a remote terminal includes a digital computer operating under the control of a specific software program.

This type of the authentication systems and methods have also at least the following disadvantages: a) the system and the system entry method are complicated; b) identification process for user's getting access to a secured environment is time-consuming, b) the system requires frequent users support by a network administrator.

U.S. Pat. No. 5,719,560 issued to Watkins in 1998 discloses an identity recognition method comprising the steps of automatically generating distinguishing information and allocating the distinguishing information to users, as well as frequently identifying users by means of a protocol in which the user enters the distinguishing information into the machine. The distinguishing information is in the form of an association between a cue and a response: such an association will hereafter be referred to as a ‘cue-response pair ’. At least one automatically generated cue-response pair is allocated to each user. Subsequent identification of an applicant as a particular user is by means of a protocol, in the course of which the machine presents to the applicant the cues from one or more cue-response pairs allocated the said user. The machine accepts from the applicant a reply for each cue presented. The machine identifies the applicant as the user if the applicant gives correct replies to a sufficient number of the cues presented, a correct reply to a cue being the response paired with the cue in a cue-response pair allocated to the user. The number of cues presented in the course of a protocol may be fixed or variable. The number of correct replies that the machine requires for the acceptance of an applicant's identity claim may be fixed, or it may be variable and it may depend on the number of incorrect replies given by the applicant in the course of the protocol.

Several disadvantages limit the application of this method. Some of them are the following: a) the long identification process for user's getting access to a secured environment, b) many errors that can be made by users during the identification process, c) demand for high level of technical support for users.

Secure access systems that provide a substantially more secure access are biometric identification systems. The biometric authentication methods and devices have been developed in response to this need. Biometric methods are based on the measurement of quantifiable biological traits. Certain biological traits, such as unique characteristics of each person's fingerprint, have been measured and compared and found to be unique or substantially unique for each person. These traits are referred to as biometric markers. The computer and electronics industry is developing identification and authentication means that measure and compare certain biometric markers with the intention of using these markers as biological “keys” or “passwords.”

Biometric markers presently used by the industry for authentication and identification include the use of measurements of unique visible features such as fingerprints, hand and face geometry, and retinal and iris patterns, as well as the measurement of unique behavioral responses such as the recognition of vocal patterns and the analysis of hand movements. The use of each of these biometric markers requires a device for presenting biological measurements in electronic form. The device may measure and compare the unique spacing of the features of a person's face or hand and compare the measured value with a value stored in the device's memory. Where the values match, the person is identified or authorized.

Several types of technologies are used in biometric identification of superficial anatomical traits. For example, biometric fingerprint identification systems may require the individual being identified to place their finger on a visual scanner. The scanner reflects light off of the person's finger and records the way the light is reflected off of the ridges that make up the fingerprint. Hand and face identification systems use scanners or cameras to detect the relative anatomical structure and geometry of the person's face or hand. Different technologies are used for biometric authentication using the person's eye. For retinal scans, a person will place their eye close to or upon a retinal scanning device. The scanning device will scan the retina to form an electronic version of the unique blood vessel pattern in the retina. An iris scan records the unique contrasting patterns of a person's iris.

Still other types of technologies are used for biometric identification of behavioral traits. Voice recognition systems generally use a telephone or microphone to record the voice pattern of the user received. Usually the user will repeat a standard phrase, and the device compares the measured voice pattern to a voice pattern stored in the system. Signature authentication is a more sophisticated approach to the universal use of signatures as authentication. Biometric signature verification not only makes a record of the pattern of the contact between the writing utensil and the recording device, but also measures and records speed and pressure applied in the process of writing.

U.S. Pat. No. 6,298,323 issued to Kaemmerer in 2001 discloses a method for recognizing a speaker, in which a voice signal is spoken into a computer by a speaker, and a feature vector is formed for the voice signal. The feature vector is compared to at least one stored reference feature vector and to at least one anti-feature vector. The reference feature vector is formed from a speech sample of a speaker to be verified. The anti-feature vector was formed from a speech sample that was spoken in by another speaker who is not the speaker to be verified. A 2-class classification is resolved by forming a similarity value and evaluating the similarity value on the basis of a predetermined range, within which the similarity value must deviate from a predetermined value so that the voice signal can be classified as deriving from the speaker to be verified.

One typical face recognition system is discloses in U.S. Pat. No. 6,111,517 issued to Atick et al in 2000. This is a video monitoring system for regulating access to a computer or another restricted environment. The recognition system employs real-time face recognition to initially detect the presence of an authorized individual and to grant the individual access to the computer system. All objects of this recognition system are accomplished by a system comprising a video input device coupled to a general purpose computer or other specialized hardware furnished with a face-recognition software program. The face recognition algorithm is capable of identifying faces in real time. The system repeatedly compares the face registered by the video input device with the facial representations of authorized individuals. When the comparison fails to indicate a match, continued access to the computer system is denied.

Several important aspects affect the application limitations of the aforementioned face recognition system. Since the selectivity of the recognition system requires a certain level of acceptability, a video input device (video camera) should be as large as 640 by 480 pixels. Current algorithms meet this challenge and accomplish real-time detection by employing either a multi-scale search strategy, a multi-cue search strategy, or both, which permits the entire field of camera view to be searched at a considerably higher speed than would otherwise be possible. Software programs for performing real-time face detection using a multi-scale and multi-cue search strategy are commercially available but they are not developed enough. All personal computers linked to restricted systems have to be equipped with expensive video cameras of an appropriate type. Additional memory resources are needed for creating and using templates memory and image memory as a portion of mentioned recognition system.

U.S. Pat. No. 4,537,484 issued to Fowler et al. in 1985 discloses a fingerprint imaging apparatus for use in an identity verification system. The system uses light, which is reflected from the finger through a system of mirrors to a linear photo diode array. The fingers are rotated mechanically in order to scan the entire fingerprint.

U.S. Pat. No. 4,544,267 issued to Shiller in 1985 discloses an identification device that uses a beam of collimated light to scan the fingerprint. The light beam is then imaged onto a linear array of photo-responsive devices. The information is processed to provide a set of signals containing fingerprint information.

U.S. Pat. No. 4,699,149 issued to Rice in 1987 discloses a device for detecting the position of subcutaneous blood vessels such as by using the reflection of incident radiation from the a user's skin. The measured pattern is then compared with a previously determined pattern to verify the identity of the user.

U.S. Pat. No. 4,728,186 issued to Eguchi et al. in 1988 discloses another method for detecting data relating to an uneven surface such as a finger, namely a fingerprint, using a light source illuminating the uneven surface through a transparent plate.

U.S. Pat. No. 4,784,484 to Jensen in 1988 discloses an apparatus for automatic scanning of a fingerprint using an optical scanner. The user slides his/her finger across a scanning surface, and an optical scanning system generates an electrical signal as a function of the movement of the finger across the optical scanning surface.

U.S. Pat. No. 5,073,950 to Colbert et al. in 1991 discloses a method and apparatus for authenticating and verifying the identity of an individual based on the profile of a hand print using an optical scanner.

U.S. Pat. No. 5,077,803 to Kato et al. in 1991 discloses a fingerprint collating system employing a biological detecting system.

U.S. Pat. No. 5,088,817 to Igaki et al. in 1992 discloses an apparatus for detecting and identifying a biological object by projecting a light beam onto the object and detecting the reflective light using an optical detector. The change in the wavelength characteristics of the light beam can be compared to a previously determined pattern.

U.S. Pat. No. 5,230,025 to Fishbine et al. in 1993 discloses a system for generating data characteristics of a rolled skin print using an optical device that can convert reflective light beams into an electronic signal and generate digital data representative of the image of the skin print.

U.S. Pat. No. 5,335,288 to Faulkner in 1994 discloses a biometric measuring apparatus that uses silhouette and light images to measure a person's hand features. The features are converted to electronic data and stored and later compared for identification purposes.

Some biometric authentication systems combine biometric measurements with conditions behavior such as signature writing styles and voice patterns or intonations. For example, U.S. Pat. No. 5,103,486 to Grippi in 1992 discloses a signature verification system utilizing a hand-held writing implement that produces data regarding a person's fingerprint pattern and their hand written signature.

U.S. Pat. No. 6,256,616 to Brookner in 2001 discloses the system for identifying the user of postal equipment where the additional identifying information supplied by the user may include personal digital data, such as a digital fingerprint or retina eye scan. A user provides identifying information, and if access is not appropriate based on that information, an additional comparison is performed before access is denied. This permits the user to select the identifying information needed for access from a set of predefined information, thereby permitting the user to change identifying information needed for access in the event the information has been or is suspected of having been compromised. Additional security may also be obtained by requiring the user to supply additional identifying information randomly selected from a predetermined set after valid first identifying information has been entered.

Other biometric authentication systems include means for verifying physiological activity. These means for verifying physiological activity are primarily prevent an unauthorized person from using dead tissues for circumventing the authentication process. For example, U.S. Pat. No. 5,719,950 to Osten et al. in 1998 discloses a personal biometric authentication system wherein inherently specific biometric parameters are measured and recognized and at least one non-specific biometric parameter is recognized and compared with physiological norms. Likewise, U.S. Pat. No. 5,737,439 to Lapsley et al. in 1998 discloses an antifraud biometric scanner that determines whether blood flow is taking place in the object being scanned and whether such blood flow is consistent with that of a living human.

Thus it has been shown that each of the prior art systems has a number of disadvantages. For example, fingerprint data bases may raise significant privacy issues for those whose information is entered in the system. Hand and facial geometry recognition systems may require large scanners and/or expensive cameras. Voice recognition devices have problems in screening out background noise. Signature recognition devices are subject to variations in the behavior of the individual. Retinal devices may require users to place their eye close to or on a scanning device, exposing the user to potential infection.

Another disadvantage of the prior art relating to biometric authentication is the limited number of biometric markers that are unique to each individual and that are practical for implementing in computer and electronic devices. Because the biometric patterns used in the prior art to authenticate a person are potentially completely unique to each person, the differences that distinguish one person from another person may be subtle. It may require a high degree of electronic sophistication to read and differentiate between the various unique aspects of the biometric marker. If the biometric marker is used to identify an individual from a large group of individuals, the computer memory storage and processing capability may also have to be sophisticated, and therefore, may be expensive.

Another disadvantage of prior art is that, with relatively few truly unique biometric markers, it is likely that use of those markers, such as a fingerprint, would be widespread. The widespread use of just one or two types of markers increases the likelihood that an unauthorized person could, by chance or otherwise, be improperly granted access. If an unauthorized person were improperly given access, that individual may have access to numerous secured devices or accounts. This is the same problem that exists when a person chooses the same password for all his accounts or electronic devices.

Another disadvantage of known biometric and non-biometric authentication/identification systems and methods is that these methods and systems do not allow the user to enter authentication data as a reliable digital signature of the user.

A common disadvantage for a majority of biometric and non-biometric user identification/recognition systems is input of the entry code with the use of expensive complicated devices and methods which make the known methods and devices unsuitable for practical use.

### OBJECTS AND SUMMARY OF THE INVENTION

Principle objects and advantages of the identity recognition system and the method in accordance with the invention are the following:

1) to provide an identity recognition system which is simple in construction and use and reliably protects the code from stealing;

2) to provide an identity recognition system and method which is characterized by short time of code enter and does not need frequent users support by a network administrator.

3) to provide the aforementioned system and method that exclude errors during the code identification process;

4) to provide a biometric identity recognition system and method which do not require the use of additional memory resources and special equipment, such as video cameras;

5) to provide the aforementioned biometric identity recognition system and method which do not raise significant privacy issues for those whose information is entered in the system, do not need the use of large scanners and/or expensive cameras, is free of background noise in the input signals, and do not expose the user to hazardous environment;

6) to apply for identification such unique biometric characteristics as user's typing style or rhythm;

7) to utilize, for recognition purposes, instants of activation and deactivation of the password entering member, e.g., moments of closing and opening of electrical contacts;

8) to utilize the elementary parameters and the primary statistical parameters representing user's typing style or rhythm by calculating activation and deactivation time intervals;

9) to use a code input pattern based on secondary statistical parameters calculated from the primary statistical parameters, which represent user's typing style or rhythm;

10) to provide an identity recognition system that adapts itself to possible behavior changes in the authorized user's typing styles or rhythms;

11) to utilize resources of the existing equipment without additional modification;

12) to apply software that is easy to install, upgrade, and adapt for successful implementation of the invented identity recognition system and method;

13) to increase the factor of security and to decrease the risk of an unauthorized access to various secured systems of civic and military nature.

14) to utilize a manner in which a user enters the authentication input data pattern into the system as his/her reliable digital signature based on aforementioned pattern.

The system and method of the invention for identity recognition are based on recognizing the instants of activation and deactivation of the password entering member, such as moments of closing and opening of electrical contacts, e.g., when the keyboard key is pushed and released. During the validation process, the user inputs one or more times the patterns of the code or password entry, and the system measures and stores parameters of the input pattern that are unique to each user, for example, time delay between inputs of the adjacent symbols, time of holding each key depressed or other specific series of activities. These parameters form the user identity data validation pattern. When the user actually requests access to the secured system and submits the entry code, these parameters are measured and compared against the previously stored data validation pattern to validate the identity of the user. Access to the secured system is granted or denied depending on the result of this comparison.

### BRIEF DESCRIPTION OF THE DRAWINGS

FIG. 1 is a block diagram of the system of the invention.

FIG. 2 is a data flow chart illustrating sequences of operations that reflect the work of the invented recognition system shown in FIG. 1.

FIG. 3a Illustrates the condition, when the user enters the n-th symbol of his/her password and begins pushing down an appropriate key, so the key's electric contacts start to close.

FIG. 3b Illustrates the condition, when the user enters the n-th symbol of his/her password and finishes pushing down an appropriate key, so the key's electric contacts start to open.

FIG. 4 is a series of curves illustrating cumulative normal distributions based on calculations made with the use of the program of identity recognition system of the invention for elementary parameters measured during entry sessions for one user.

FIG. 5 is a single curve illustrating the total cumulative normal distribution based on calculations made by the program of identity recognition system of the invention for elementary parameters measured during entry sessions for the same user as in FIG. 4.

FIG. 6 is a series of graphs illustrating total cumulative normal distributions based on calculations made with use of the program of the invented identity recognition system for all elementary parameters measured during entry sessions for three different users.

### DETAILED DESCRIPTION OF THE INVENTION

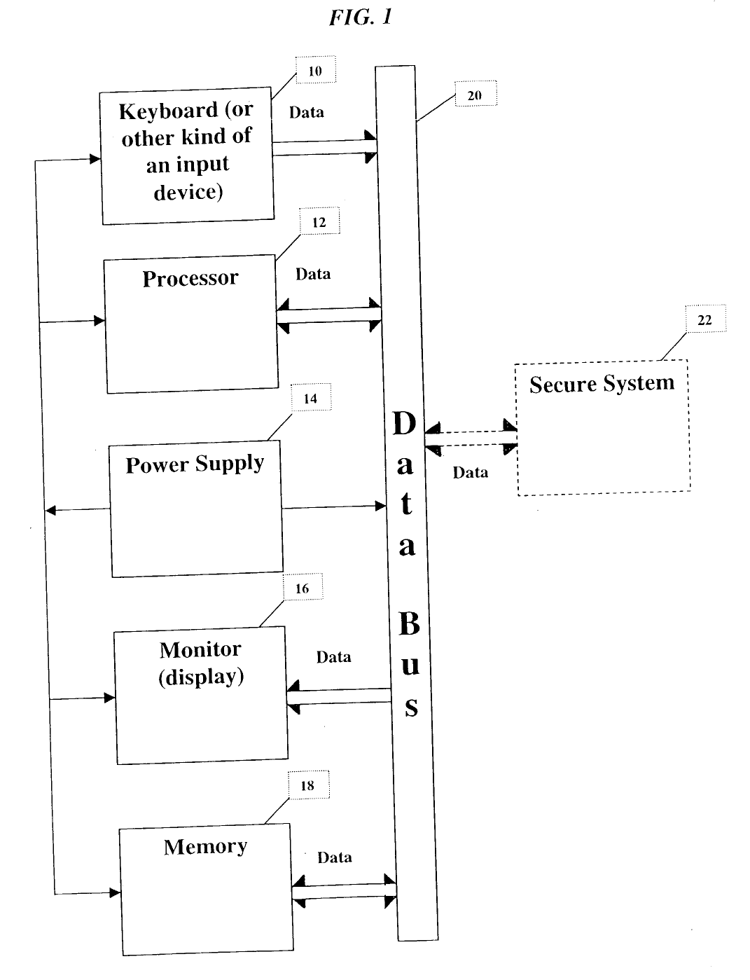

The block diagram of the invented securing system, which hereinafter will be referred to as “identity recognition system” or “recognition system”, and its units having the appropriate reference numerals are shown in FIG. 1. The invented identity recognition system comprises a keyboard or another kind of an input device 10 hereinafter referred to as “keyboard”, a processor 12, a power supply 14, a monitor or a display 16, and a memory 18, which are connected in parallel to a data bus 20. A secured system 22 that always has to be protected from unauthorized users' accesses is not a part of the described invented identity recognition system but both aforementioned systems have a bi-directional link to each other. A power supply has links to all other identity recognition units of the system (10. 12, 16, 18 and 20) and feeds them with the voltages required for their normal operations. The data bus 20 transmits data between two or more units shown in FIG. 1 (except the unit 14). The keyboard 10 (or another kind of an input device) is utilized by a user for his/her entering two types of the following information: a) a user login name and password to get the access to the secured system 22 and b) various data during the communication between an authorized user and the secured system 22. The keyboard 10 (or another kind of an input device) has a unidirectional link to the data bus 20. The processor 12 is the main unit of the invented identity recognition system shown in FIG. 1 as it controls the normal data flow among all the units of the invented identity recognition system (except the unit 14) and the data flow between the invented identity recognition system and the secured system 22. The processor 12 also performs all logic/math operations in accordance with the software stored in the memory unit 18. Other important functions fulfilled by the processor 12 consist of enabling the permission command signal for authorized user's access to the secured system 22 and utilizing a bidirectional link to the data bus 20.

The monitor (display) 16 gets a data from the data bus 20 through a unidirectional link and displays user name and password symbols and other information that the user exchanges with the invented identity recognition system. By means of the bidirectional link to the data bus 20, the memory unit 18 saves and stores the following information: a) appropriate software applications based on invented identity recognition method; b) data of all parameters related to user password symbols, which were entered by a user during his/her previous enter sessions; c) other kinds of software applications and data that are required for normal operation of aforementioned identity recognition system.

Depending on a specific application, the invented identity recognition system and method can be released with different versions of the appropriate hardware and software based on the invented identity recognition method. Any of the aforementioned software versions can be created as one of the following file types: ActiveX.dll, ActiveX.exe, EXE module, or the like.

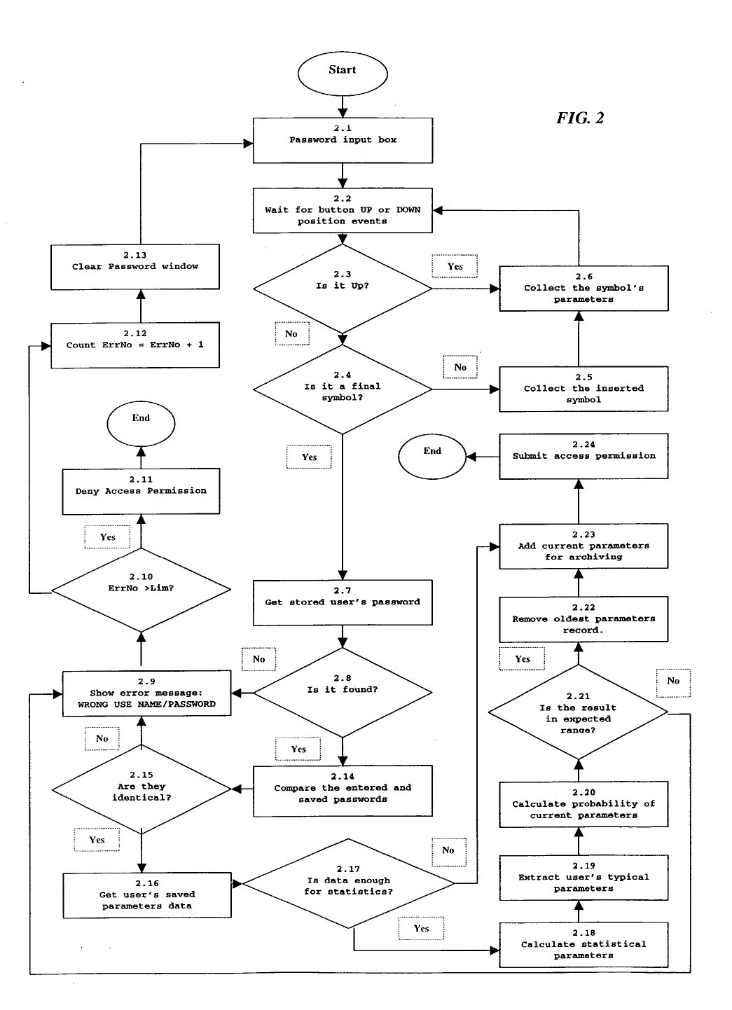

One of the most common examples suitable for application of the system and method of the invention is an access to a standard personal computer with a memory unit 18 comprising a record medium, e. g., a special hard disk with a specific software, which is shown in FIG. 2 in the form of a flow chart. This software is based on the identity recognition method of the present invention. As shown in FIG. 1, the personal computer's processor 12 is also linked to the secured system 22 through the data bus 20.

In a personal computer the aforementioned specialized software, which is a part of the invented method, can be activated by one of the following ways: loading the appropriate software files into the personal computer's memory unit 18 represented by the specific hard disk (Way 1) or incorporating the same files into existing operation system of the personal computer (Way 2), or by other ways. In accordance with Way 1, prior to start, the network administrator or another authorized person installs the aforementioned specialized software. This can be done by loading the software into the memory unit 18 of the personal computer from the following alternative sources: a) an installation floppy disk, b) an installation CD-ROM or c) an appropriate Internet website that can be created for this purpose in advance.

Before the user accesses the secured system 22, he/she sees a pop-up window (step 2.1 in FIG. 2) on the monitor unit 16. This window contains empty input boxes for entry of the user name and password.

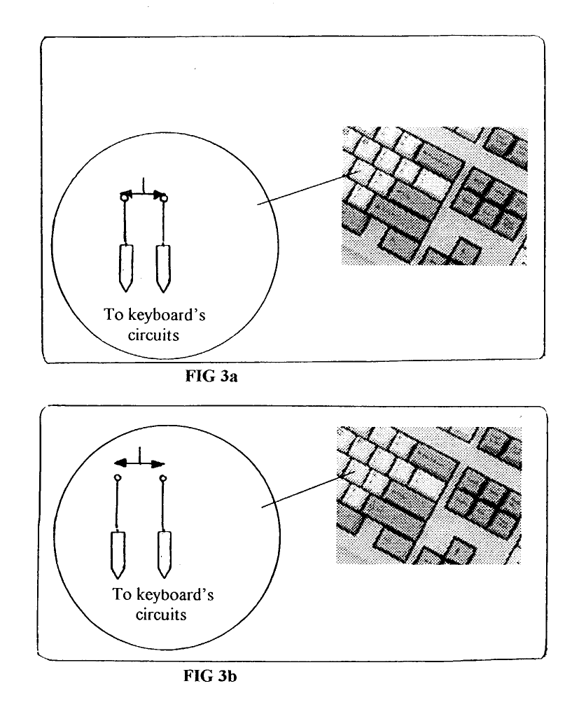

The invented identity recognition system waits for the event (step 2.2 in FIG. 2) associated with a key position on the keyboard 10 during the user name and password entry session. At the moment of time t (n_down), when a user enters the n-th symbol and finishes pushing down the appropriate key, the key's electric contacts start to close. This is schematically shown in FIG. 3a.

It is understood that the keyboard with keys for entering the code identification information are shown only as an example and that the code identification information can be entered through such input devices as buttons or pedals.

At the moment of time t (n_up), when the user enters the n-th symbol and lets the pushed key move up (step 2.3 in FIG. 2), the key's electrical contacts start to open. This condition is schematically shown in FIG. 3b. The invented identity recognition system collects this entered n-th symbol (step 2.5 in FIG. 2) and its time-based parameters

t (n_up) and t (n_down) (step 2.6 in FIG. 2).

After the user enters any symbol of his/her username/password, the processor 12 checks whether the entered symbol is final (step 2.4 in FIG. 2), and if it is, the current entry session ends. When the session ends, and if the processor 12 does not find the entered user name against the list of user names (step 2.7 in FIG. 2) saved in the memory unit 18, or the entered password mismatches the saved password during their comparison done by the processor 12 (steps 2.14 and 2.15 in FIG. 2), the processor 12 generates a command indicating the wrong user (step 2.9 in FIG. 2). In addition, the processor 12 also counts the number of unsuccessful user name/password entry attempts for the current password entry session and compares this number with the maximum allowed number for user name/password entry attempts per session (step 2.10 in FIG. 2), which is stored in the memory unit 18. If this maximum allowed number is exceeded, the processor 12 does not generate a permission command for user access to the secured system 22 and sends the “permission denied” message (step 2.11 in FIG. 2) to the monitor 16.

If the maximum allowed number for user name/password entry attempts per session is not exceeded, the processor increments the attempt's number counter by one (step 2.12 in FIG. 2) and clears the password input box on the monitor 16 for the next user's password entry session (step 2.13 in FIG. 2).

Every time when the entered and saved passwords match (step 2.15 in FIG. 2), the processor 12 loads the saved password input parameters data from the memory unit 18 archive and checks this data. If this data is not sufficient for statistical analysis (step 2.17 in FIG. 2), the processor adds the entered password input parameters data to the archive (step 2.23 in FIG. 2). At the same time, the user receives a permission (step 2.24 in FIG. 2) to access the secured system 22.

The portion of the program described above represents a pre-adaptive mode of the invented identity recognition system when the system processor 12 checks the identity of entered and saved user password symbols and their parameters. The invented identity recognition system works in this mode until accumulated parameters related to the particular user are sufficient for the statistical analysis. Since this moment of time the aforementioned system starts working in the self-adaptive mode serving aforementioned particular user. This means that the invented identity recognition system constantly adapts itself to little changes that may occur in the nature of the data entry by a specific used from session-to-session, day-to-day, week-to-week or month-to-month periods. Such changes may relate to a typing style or rhythm of aforementioned particular authorized user. If the processor 12 determines that aforementioned data retrieved from archive is sufficient for statistical analysis, the processor 12 calculates elementary parameters of the user typing style based on such parameters as t (n_down) and t (n_up) and the primary statistical parameters in accordance with the statistical analysis (step 2.18 in FIG. 2). The elementary parameters may comprise, but not be limited to, the following calculated time intervals:

T (1_up.1_down)=t (1_up)−t (1_down)

T (2_up.2_down)−t (2_up)−t (2_down)

T (n_up.n_down)=t (n_up)−t (n_down)

and

T (2_down.1_up)=t (2_down)−t (1_up)

T (3_down.2_up)=t (3_down)−t (2_up)

T (n+1_down.n_up)=t (n+1_down)−t (n_up),

where:

T (1_up.1_down)—the time interval between the moments of time t (1_up) when a user enters the 1-st symbol and lets the pushed key move up, the key's electrical contacts start to open (FIG. 3b) and the moments of time t (1_down), when a user enters the 1-st symbol and finishes pushing down the key, the key's electric contacts start to close (FIG. 3a). T (2_up.2_down)—the time interval between the moments of time t (2_up) when the user enters the 2-nd symbol and lets the pushed key move up, the key's electrical contacts start to open (FIG. 3b) and the moments of time t (2_down), when a user enters the 2-nd symbol and finishes pushing down the key, the key's electric contacts start to close (FIG. 3a).

T (n_up.n_down)—the time interval between the moments of time t (n_up) when the user enters the n-th symbol and lets the pushed key move up, the key's electrical contacts start to open (FIG. 3b) and the moments of time t (n_down), when a user enters the n-th symbol and finishes pushing down the key, the key's electric contacts start to close (FIG. 3a).

Also

T (2_down.1_up)—the time interval between user's entry of the 1-st and the 2-nd password symbols.

T (3_down.2_up)—the time interval between user's entry of the 2-nd and the 3-rd password symbols.

T (n+1_down.n_up)—the time interval between user's entry of the n-th and the (n+1)-th password symbols

Also

t (1_down)—the moment of time when the user enters the 1-st password symbol and finishes pushing down the key, which electric contacts start to close (FIG. 3a).

t (2_down)—the moment of time when the user enters the 2-nd password symbol and finishes pushing down the key, which electric contacts start to close (FIG. 3a).

t (n_down)—the moment of time when the user enters the n-th password symbol and finishes pushing down the key, which electric contacts start to close (FIG. 3a).

Also

t (1_up)—the moment of time when the user enters the 1-st password symbol and releases the pushed key, which electric contacts start to open to move up (FIG. 3b).

t (2_up)—the moment of time when the user enters the 2-nd password symbol and releases the pushed key, which electric contacts start to open, to move up (FIG. 3b).

t (n_up)—the moment of time when the user enters the n-th password symbol and releases the pushed key, which electric contacts start to open, to move up (FIG. 3b).

The primary statistical parameters may comprise, but not be limited to, averages and standard deviations calculated on the base of aforementioned elementary parameters.

After completing those calculations, the processor 12 extracts only those primary statistical parameters that are the most typical ones for the current user and represent the current user's typing style or rhythm in the best manner (step 2.19 in FIG. 2). This extraction is desired but not indispensable for the system as it may be used only for increasing the sensitivity of the invented identity recognition method and system. Then the processor 12 calculates the particular user's secondary statistical parameter based on the primary statistical parameters (step 2.20 in FIG. 2) that are the most typical for the particular user. Aforementioned secondary statistical parameter can be represented by but not limited to the probability. The processor also checks whether this secondary statistical parameter' value is within the expected range (step 2.21 in FIG. 2). This range is set up either automatically or by a software engineer for each version of the particular invented identity recognition system during its creation.

In other words, the identification code is inputted into the identity recognition system of the invention by repeating the entry sessions and memorizing the measured elementary parameters in each entry session for statistical determination of reference relationships between the hidden characteristics of the entry signals. The individual, who tries to enter the system, is given or denied a permission to entry the system, depending on whether the current input pattern information coincides or does not coincide with the aforementioned reference relationships.

Upon receiving a positive result of aforementioned check, the processor deletes the oldest records of the statistical parameters for this specific user (step 2.22 in FIG. 2), adds the current record of the statistical parameters (step 2.23 in FIG. 2) to the archive of the memory unit 18 and submits the permission for the access of the particular user (step 2.24 in FIG. 2) to a secured system 22.

Upon receiving a negative result of aforementioned check, the processor sends the “wrong user” message to the monitor 16. In addition, the processor 12 also counts the number of unsuccessful user name/password entry attempts for the current password entry session and compares this number with the maximum allowed number for user name/password entry attempts per session for this specific user (step 2.10 in FIG. 2), which is stored in the memory unit 18. If maximum allowed number is exceeded, the processor 12 does not generate a permission command for the particular user's access to the secured system 22 and sends a “permission denied” message (step 2.11 FIG. 2) to the monitor 16. If the maximum allowed number for user name/password entry attempts per session is not exceeded, the processor increments the attempt's number counter by one (step 2.12 in FIG. 2) and clears the user password input box on the monitor 16 for the next user's password entry session (step 2.13 in FIG. 2).

To conclude the detailed description of the invented recognition system, it is necessary to highlight the following features:

1. The user password may contain one or more symbols. An increase in the number of symbols used in the password, improves selectivity of the invented identity recognition system and reduces the risk of unauthorized access to the secured system 22. If the password has less then six symbols, the risk of unauthorized access can be reduced simultaneously with improvement in selectivity by differentiating the typing style or typing rhythm.

2. Most of the time, the invented identity recognition system works in a self-adaptive mode serving particular users.

3. The individual handwriting style is as unique for each person as painting style for each artist, playing style for each musician, and Morse code style or rhythm for each operator who transmits messages by Morse-code keying. The experts in each of the listed activities can distinguish between performances by two different people even if they tried to do absolutely the same thing. Similar to these individual individualities, the invented identity recognition system recognizes the unique typing style or rhythm inherent in each individual. Instead of a human expert, the invented identity recognition system that works in self-adaptive mode distinguishes between the typing styles or rhythms of authorized and unauthorized users, even if they enter the same password. In the case of the attempt of unauthorized entry, the invented identity recognition system blocks the access to the secured system 22 for the unauthorized user.

4. The feature mentioned in Item 3 above makes it possible to utilize a manner in which the users enter their authentication data as an equivalent to digital signatures.

5. On the basis of a personal computer with the memory unit 18 in the form of a special hard disk with an appropriate program shown by the flowchart of FIG. 2, the inventors have developed a pilot identity recognition system of the invention shown in FIG. 1.

The invented identity recognition system and method were tested on real models and described in practical examples given below:

### PRACTICAL EXAMPLE 1

The experiment was carried out for the following purposes:

a. obtaining experimental confirmation of that fact that each person/user has his/her unique printing style or rhythm and that the aforementioned style can be represented in a unique format that looks as a specific plot created on the basis of parameters related to the particular user password entry symbols and

b. obtaining experimental confirmation of the fact that aforementioned parameters and their corresponding unique visual format can represent user's reliable digital signature.

The invented identity recognition system/method and related software application were tested under simulated conditions (different from real time conditions) when each user conducted a password entry session. Under the simulated conditions these sessions did not occur simultaneously, and after their completion the results were saved into files specific for each user. After all the users completed their password entry sessions, the saved data were sent from each aforementioned file to the system of the invention for processing by the invented method.

The invented identity recognition system and method were tested by the Visual Basic implementation (application 1) of the algorithm/sequence of operations illustrated in FIG. 2. There was a panel of 12 participants in this experiment and only one of them was the authorized user. Every participant entered the same password “testmenow”. Several participants entered this password at least 10 times and the rest of them did this at least 6 times. The data of measured parameters of entered password symbols belonging to each individual during all his/her entry sessions were stored in a separate file. TAB. 1 shows a sample set of all elementary parameters (measured in milliseconds) which values were measured by the invented identity recognition system during all password entry sessions for each user. The collected data on each user was used in further statistical analysis performed by invented identity recognition system.

TABLE 1
ELEMENTARY PARAMETERS' VALUES (measured in milliseconds)

| n/n | p1 | p2 | p3 | p4 | p5 | p6 | p7 | p8 | p9 | p0 | pA | pB | pC | pD | pE | pF | pG | pH | pI | pJ | pK | pL | pM | pN |
|---|---|---|---|---|---|---|---|---|---|---|---|---|---|---|---|---|---|---|---|---|---|---|---|---|
| 1 | 16 | 16 | 17 | 28 | 16 | 22 | 5 | 60 | 11 | 44 | 11 | 49 | 6 | 44 | 11 | 22 | 11 | 66 | 11 | 44 | 11 | 39 | 11 | 38 |
| 2 | 11 | 22 | 11 | 28 | 11 | 22 | 5 | 71 | 6 | 28 | 11 | 54 | 6 | 44 | 11 | 28 | 11 | 49 | 11 | 39 | 11 | 27 | 17 | 39 |
| 3 | 11 | 17 | 16 | 27 | 17 | 28 | 11 | 66 | 16 | 33 | 11 | 60 | 6 | 39 | 11 | 27 | 11 | 44 | 11 | 38 | 11 | 22 | 17 | 50 |
| 4 | 11 | 22 | 6 | 22 | 11 | 22 | 6 | 61 | 11 | 22 | 16 | 38 | 16 | 49 | 11 | 28 | 11 | 71 | 11 | 39 | 5 | 44 | 11 | 38 |
| 5 | 11 | 17 | 16 | 27 | 17 | 28 | 11 | 55 | 11 | 33 | 11 | 33 | 11 | 49 | 6 | 28 | 10 | 60 | 11 | 49 | 6 | 17 | 16 | 38 |
| 6 | 11 | 17 | 11 | 22 | 22 | 27 | 6 | 60 | 11 | 28 | 11 | 38 | 17 | 50 | 5 | 16 | 11 | 50 | 11 | 44 | 11 | 16 | 17 | 44 |
| 7 | 6 | 17 | 11 | 22 | 22 | 27 | 11 | 66 | 11 | 39 | 11 | 33 | 5 | 54 | 11 | 22 | 11 | 55 | 11 | 39 | 11 | 22 | 16 | 49 |
| 8 | 11 | 22 | 5 | 21 | 17 | 28 | 11 | 66 | 11 | 22 | 16 | 44 | 5 | 44 | 11 | 22 | 16 | 60 | 11 | 39 | 11 | 16 | 16 | 38 |
| 9 | 11 | 22 | 5 | 22 | 16 | 22 | 11 | 66 | 5 | 27 | 11 | 38 | 6 | 44 | 11 | 22 | 11 | 50 | 5 | 33 | 11 | 16 | 22 | 39 |
| 10 | 11 | 16 | 11 | 22 | 17 | 22 | 17 | 66 | 6 | 28 | 5 | 38 | 11 | 55 | 11 | 17 | 11 | 49 | 11 | 33 | 11 | 33 | 11 | 44 |
| 11 | 11 | 16 | 6 | 22 | 22 | 28 | 5 | 71 | 11 | 22 | 11 | 44 | 11 | 49 | 11 | 22 | 11 | 88 | 6 | 44 | 11 | 17 | 16 | 38 |
| 12 | 11 | 16 | 11 | 22 | 17 | 28 | 11 | 71 | 11 | 28 | 11 | 38 | 11 | 44 | 11 | 22 | 11 | 49 | 6 | 33 | 11 | 22 | 11 | 39 |
| 13 | 11 | 16 | 11 | 22 | 17 | 28 | 5 | 66 | 11 | 27 | 11 | 71 | 11 | 61 | 5 | 16 | 11 | 83 | 11 | 38 | 11 | 22 | 11 | 39 |
| 14 | 17 | 17 | 11 | 27 | 11 | 22 | 6 | 66 | 11 | 33 | 11 | 33 | 6 | 55 | 6 | 27 | 6 | 66 | 11 | 44 | 11 | 17 | 16 | 44 |
| 15 | 16 | 16 | 11 | 28 | 22 | 27 | 6 | 49 | 17 | 28 | 16 | 38 | 11 | 66 | 11 | 22 | 11 | 61 | 5 | 44 | 11 | 27 | 11 | 39 |
| 16 | 17 | 17 | 11 | 22 | 16 | 21 | 11 | 66 | 11 | 39 | 11 | 38 | 6 | 55 | 6 | 17 | 11 | 71 | 6 | 44 | 6 | 17 | 10 | 43 |
| 17 | 11 | 17 | 11 | 22 | 11 | 16 | 11 | 60 | 11 | 28 | 11 | 49 | 6 | 44 | 6 | 22 | 6 | 50 | 11 | 44 | 5 | 16 | 11 | 39 |
| 18 | 11 | 17 | 11 | 22 | 11 | 16 | 17 | 66 | 11 | 28 | 11 | 44 | 11 | 38 | 11 | 17 | 16 | 60 | 5 | 44 | 11 | 16 | 17 | 44 |
| 19 | 11 | 16 | 6 | 22 | 11 | 22 | 6 | 66 | 11 | 22 | 11 | 44 | 6 | 44 | 5 | 16 | 11 | 77 | 6 | 33 | 6 | 17 | 11 | 38 |
| 20 | 11 | 17 | 11 | 27 | 17 | 17 | 5 | 71 | 11 | 38 | 11 | 39 | 11 | 60 | 11 | 22 | 11 | 55 | 6 | 44 | 11 | 22 | 11 | 55 |
| 21 | 17 | 17 | 11 | 22 | 11 | 16 | 11 | 66 | 6 | 28 | 11 | 38 | 6 | 55 | 6 | 17 | 11 | 44 | 5 | 32 | 11 | 22 | 11 | 39 |
| 22 | 11 | 17 | 11 | 27 | 11 | 22 | 11 | 66 | 11 | 28 | 11 | 49 | 6 | 39 | 11 | 22 | 11 | 55 | 11 | 49 | 11 | 16 | 17 | 39 |
| 23 | 5 | 11 | 11 | 22 | 11 | 22 | 5 | 66 | 5 | 22 | 11 | 44 | 11 | 55 | 5 | 16 | 11 | 44 | 11 | 33 | 11 | 16 | 17 | 44 |
| 24 | 11 | 22 | 11 | 22 | 17 | 22 | 11 | 61 | 11 | 27 | 11 | 38 | 6 | 50 | 11 | 27 | 11 | 55 | 11 | 39 | 5 | 22 | 16 | 38 |
| 25 | 11 | 22 | 6 | 22 | 17 | 22 | 11 | 61 | 11 | 27 | 11 | 33 | 11 | 55 | 11 | 22 | 11 | 55 | 11 | 49 | 11 | 22 | 17 | 39 |
| 26 | 11 | 17 | 11 | 22 | 16 | 22 | 11 | 60 | 11 | 22 | 11 | 39 | 11 | 38 | 11 | 22 | 11 | 44 | 6 | 33 | 11 | 22 | 11 | 38 |
| 27 | 6 | 17 | 11 | 27 | 11 | 27 | 6 | 61 | 11 | 33 | 5 | 33 | 11 | 49 | 6 | 28 | 11 | 38 | 11 | 33 | 11 | 22 | 11 | 39 |
| 28 | 11 | 22 | 6 | 22 | 11 | 28 | 11 | 49 | 11 | 39 | 11 | 38 | 5 | 49 | 11 | 22 | 17 | 44 | 11 | 39 | 5 | 16 | 11 | 39 |
| 29 | 11 | 21 | 11 | 22 | 17 | 28 | 5 | 66 | 5 | 27 | 11 | 55 | 11 | 44 | 11 | 22 | 11 | 33 | 11 | 33 | 11 | 22 | 11 | 38 |
| 30 | 6 | 17 | 11 | 22 | 11 | 22 | 11 | 66 | 11 | 22 | 16 | 44 | 11 | 38 | 11 | 16 | 11 | 44 | 6 | 33 | 11 | 22 | 11 | 39 |
| 31 | 5 | 22 | 5 | 22 | 11 | 22 | 11 | 60 | 11 | 22 | 17 | 39 | 5 | 44 | 11 | 27 | 11 | 60 | 6 | 33 | 11 | 22 | 11 | 39 |
| 32 | 11 | 22 | 5 | 22 | 11 | 22 | 11 | 66 | 5 | 44 | 11 | 38 | 6 | 44 | 11 | 17 | 11 | 66 | 5 | 44 | 5 | 16 | 11 | 38 |
| 33 | 11 | 16 | 11 | 17 | 16 | 22 | 5 | 55 | 11 | 33 | 11 | 33 | 11 | 44 | 5 | 22 | 5 | 43 | 6 | 33 | 11 | 22 | 11 | 39 |
| 34 | 17 | 22 | 6 | 17 | 16 | 21 | 11 | 61 | 11 | 33 | 11 | 38 | 11 | 39 | 5 | 16 | 11 | 50 | 11 | 33 | 11 | 16 | 17 | 44 |
| 35 | 6 | 17 | 5 | 22 | 16 | 16 | 11 | 66 | 11 | 28 | 16 | 44 | 11 | 49 | 16 | 27 | 6 | 44 | 6 | 33 | 6 | 17 | 16 | 38 |
| 36 | 11 | 16 | 6 | 22 | 16 | 22 | 5 | 60 | 11 | 33 | 11 | 50 | 11 | 66 | 5 | 22 | 11 | 55 | 5 | 44 | 7 | 11 | 16 | 43 |
| 37 | 11 | 11 | 5 | 16 | 17 | 28 | 5 | 60 | 11 | 22 | 11 | 38 | 6 | 44 | 6 | 22 | 6 | 50 | 5 | 38 | 11 | 17 | 11 | 44 |
| 38 | 6 | 11 | 17 | 22 | 16 | 27 | 6 | 55 | 17 | 28 | 11 | 44 | 5 | 44 | 11 | 22 | 11 | 55 | 5 | 38 | 11 | 17 | 11 | 38 |
| 39 | 5 | 16 | 11 | 28 | 11 | 16 | 11 | 61 | 5 | 22 | 11 | 38 | 11 | 60 | 6 | 17 | 16 | 60 | 6 | 39 | 11 | 22 | 11 | 44 |
| 40 | 11 | 16 | 6 | 17 | 16 | 22 | 11 | 71 | 11 | 22 | 11 | 44 | 5 | 33 | 11 | 49 | 11 | 66 | 11 | 39 | 5 | 16 | 17 | 44 |
| 41 | 11 | 11 | 11 | 22 | 11 | 22 | 6 | 61 | 11 | 27 | 11 | 49 | 11 | 44 | 11 | 22 | 17 | 66 | 11 | 33 | 11 | 17 | 16 | 44 |
| 42 | 6 | 6 | 11 | 22 | 16 | 16 | 11 | 66 | 11 | 22 | 11 | 55 | 11 | 39 | 11 | 22 | 11 | 55 | 5 | 33 | 5 | 16 | 11 | 38 |
| 43 | 16 | 16 | 6 | 22 | 11 | 17 | 5 | 60 | 11 | 22 | 11 | 39 | 11 | 38 | 6 | 17 | 16 | 71 | 5 | 38 | 11 | 17 | 11 | 38 |
| 44 | 11 | 16 | 6 | 16 | 11 | 17 | 11 | 66 | 11 | 16 | 11 | 39 | 11 | 38 | 11 | 22 | 11 | 55 | 11 | 39 | 11 | 16 | 17 | 44 |

Notes to Table 1:
1. p1, p2 . . . pN (the upper row of the table) - the desiganations of measured elementary parameters for the same user.
2. 1, 2 . . . 44 (the most left column of the table) - the numerals of entry sessions for the same user.
3. Each row starting from the second one represents all elementary parameters' values measured during each entry password session for the same user.
4. Each column starting from the second one represents each elementary parameter's values measured during all entry password sessions for the same user.

In order to capture the moments t (n_up) and t (n_down) (step 2.6 in FIG. 2) of “Up-Key” and “Down-Key” events, appropriate time measuring functions built into Visual Basic language were used. Utilization of high-level language caused some discrepancies in capturing moments of the events, and, therefore, in further calculations, as the operation system could not always immediately transfer control to the identity recognition system. Nonetheless, the test results display distinctive differences in each individual's password entry.

The test of invented method was performed in the following way:

The invented identity recognition system program was executed in the password validation mode first for those users, who already had enough data stored to conduct conclusive analysis. In this case the program automatically calculated and stored values of such primary statistical parameters as Average and Standard Deviation for each measured elementary parameter. An example of values of the primary statistical parameter for one of such users is displayed in TAB 2.

TABLE 2
PRIMARY STATISTICAL PARAMETER VALUES
(measured in milliseconds)

| pN | Average | Standard deviation |
|---|---|---|
| p1 | 10.79545 | 3.286194 |
| p2 | 17.13636 | 3.513551 |
| p3 | 9.54545 | 3.353794 |
| p4 | 22.59091 | 3.113885 |
| p5 | 14.75000 | 3.491060 |
| p6 | 22.59091 | 4.063799 |
| p7 | 8.86363 | 3.258492 |
| p8 | 63.15909 | 5.165195 |
| p9 | 10.36364 | 2.755910 |
| p0 | 28.31818 | 6.330922 |
| pA | 11.43182 | 2.260307 |
| pB | 42.31818 | 7.824126 |
| pC | 8.95454 | 3.081872 |
| pD | 47.40909 | 7.843116 |
| pE | 9.00000 | 3.096919 |
| pF | 22.11364 | 5.617408 |
| pG | 11.11364 | 2.647605 |
| pH | 56.04545 | 11.520640 |
| pI | 8.38636 | 2.756941 |
| pJ | 38.61364 | 5.139932 |
| pK | 9.34091 | 2.827971 |
| pL | 20.20455 | 6.107296 |
| pM | 13.61364 | 3.039258 |
| pN | 40.95455 | 3.783664 |

Note to Table 2:
p1, p2 . . . pN - designations of elementary parameters which values were utilized for calculation of such primary statistical parameters as Average and Standard deviation values (shown in the table) belonging to the same user having prerecorded data.

For the next step, the aforementioned program calculated such secondary statistical parameter as probability of appearance of each elementary parameter value in participant's data files and then the total probability of appearance of all elementary parameter values in participant's data file was determined. The total probability of the occurrence of values for all elementary parameters was calculated using the principle of cumulative normal distribution. For each user, this total probability value was compared with the minimum probability value from the calculations based on the authorized user's previously obtained lists of parameters values.

The results of the test were automatically registered on the invented identity recognition system's output to the special file. If the calculated total probability value was higher than the defined acceptable minimum, then the output “True” was written to the special file, otherwise the written output was “False”.

The above experiment was performed completely only for those users who had at least 10 password entry sessions. (There were 10 lists of elementary parameters already stored for each user).

Experiment 1 was done three times from its start to the end, and each time the authorized user was represented by a different person.

Test results of the Experiment 1 demonstrate the following positive aspects:

1. All parameters belonging to the unauthorized users were identified by the program of the invented identity recognition system as not acceptable, and access to the secured system for such users was denied.

2. The calculated probability (secondary statistical parameter) values belonging to unauthorized users were at least 30% less than minimal allowed probability value. This difference can be considered as a good criterion for reliable distinction between authorized and unauthorized users.

3. 90-95% of the password entry sessions belonging to authorized users successfully passed the control of their secondary statistical parameter (probability) values and were identified by the aforementioned program as acceptable for opening access to the secured system.

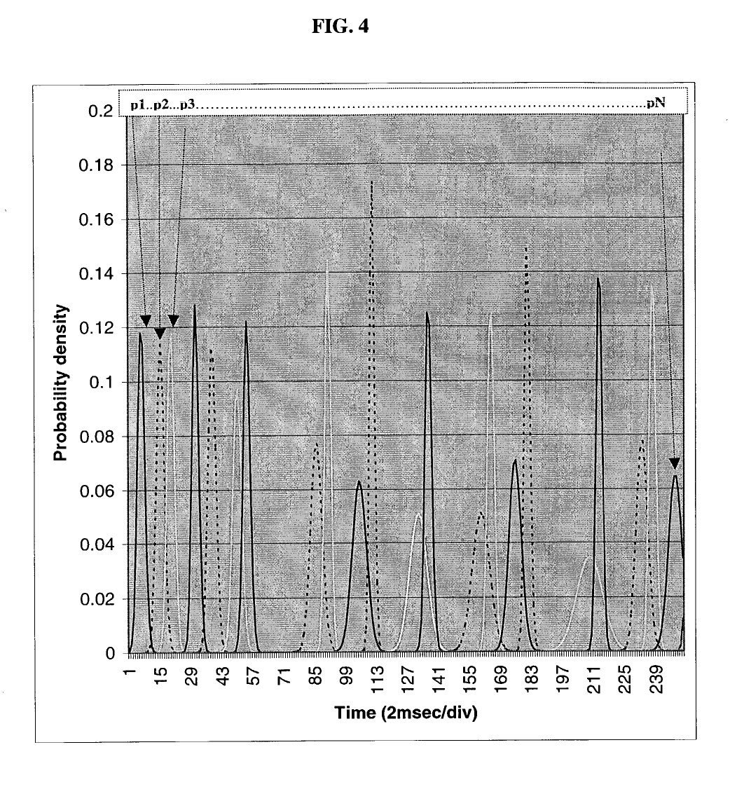

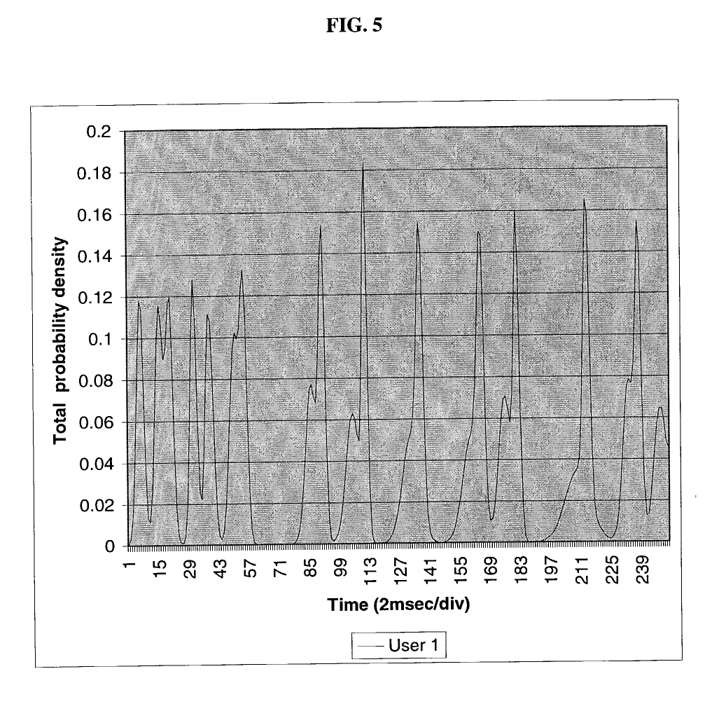

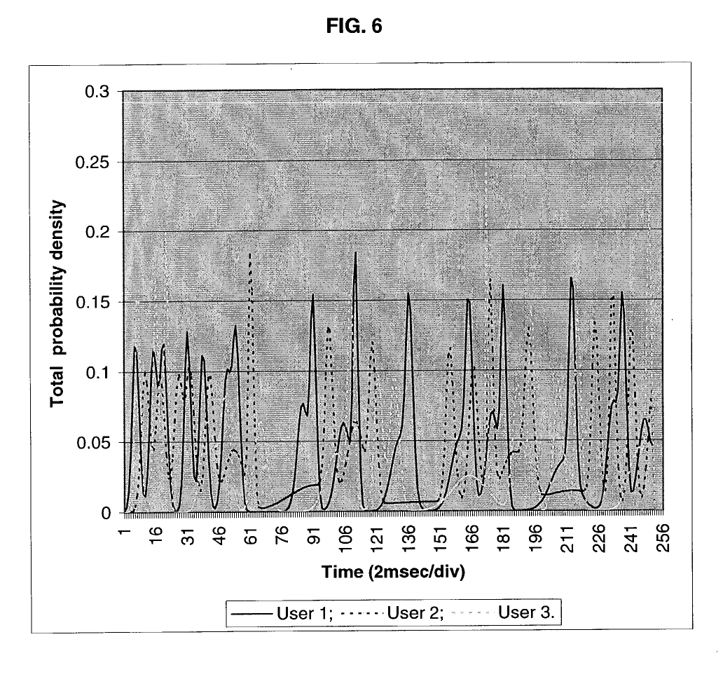

4. Sever graphs shown in FIG. 4, FIG. 5 and FIG. 6 that comprise visual representation of the printing style or rhythm of the users were created on the basis of the data obtained in Experiment 1. FIG. 4 shows a series of curves illustrating cumulative normal distributions based on calculations done by the program of the invented identity recognition system for each elementary parameter. The values of these parameters (shown in TAB 1) were measured during all password entry sessions for the same user. FIG. 5 is a graph illustrating the total cumulative normal distribution based on calculations done by the program of the invented identity recognition system for all elementary parameters. The values of these parameters (shown in TAB 1) were measured during all password entry sessions for the same user. FIG. 6 shows a series of curves illustrating the total cumulative normal distributions based on calculations done by the program of the invented identity recognition system for all elementary parameters. The values of these parameters (shown in TAB 1) were measured during all password entry sessions for three different users.

5. The visual formats that represent the typing style or rhythm for the aforementioned three users (FIG. 6) can be considered as a significant proof testifying to the fact a manner in which a user enters the authentication input data pattern into the system of the invention by the method of the invention are suitable for use as a digital signature for identification of an individual.

### Experiment 2

The invented identity recognition system and method were tested by the Visual Basic implementation (application 2) of the algorithm illustrated in FIG. 2. There were 3 participants in this experiment and all of them were the authorized users. Each of them performed 10 password entry sessions.

Three authorized users tested the invented identity recognition method and the real pilot model of invented identity recognition system represented by the personal computer with the memory comprising a hard disk with aforementioned software implementation. Authorized users performed these tests in real time conditions with the following result: about 95% of users' password entry attempts were successful for getting an access to the secured system.

Using the invented identity recognition system for entering their passwords, all users spent the same time as they usually spend for their password entry process in existing well-known identity recognition systems based on PIN/password identification principles. No help from network administrators or technical support engineers was needed for users during the tests.

Even in the above-described implementation conducted under simplifies experimental condition proved that the invented identity recognition system has high reliability in protecting the secured systems. Further improvements in the measuring and data processing techniques may significantly increase capabilities of invented identity recognition system and method.

Thus, it has been shown that the method and system of the invention makes it is possible:

1) to simplify construction and use and reliably protect the code from stealing;

2) to shorten time of code enter and exclude a need in frequent users support by a network administrator.

3) to exclude entering errors during the code identification process;

4) to exclude a need in additional memory resources and special equipment, such as video cameras;

5) to exclude a need in significant privacy issues for those whose information is entered in the system, to exclude the use of large scanners and/or expensive cameras, to prevent background noise in the input signals, and to protect the user from expose to hazardous environment.

6) to apply such unique biometric characteristics as user's typing style or rhythm for personal identity check of the user.

7) to utilize for recognition instants of activation and deactivation of the password entering member, such as moments of closing and opening of electrical contacts.

8) to utilize the primary statistical parameters representing user's typing style or rhythm by calculating activation and deactivation time intervals.

9) to use a code input pattern based on secondary statistical parameters calculated from the primary statistical parameters, which represent user's typing style or rhythm.

10) to provide the aforementioned identity recognition system which adapts itself to possible behavior changes in the authorized user's typing styles or rhythms.

11) to utilize resources of an existing equipment without any additional modernization.

12) to appropriate versions of the software that is easy to install, upgrade, and adapt for the successful operation of the invented identity recognition system and method.

13) to increase the factor of security and to decrease the risk of an unauthorized access to the various secured systems of civic and military nature.

14) to utilize a manner in which a user enters the authentication input data pattern into the system as his/her reliable digital signature based on aforementioned pattern.

Although the description that is given above contains many specificities, these should not be interpreted as limiting the scope of invention, but as merely providing illustrations of the preferred embodiments of this invention. It is understood that none of the identification code input patterns will be exactly the same as the reference pattern stored in the system and that it should coincide therewith in the range of specified probability.

For example, invented identity recognition system can comprise units (shown in FIG. 1) that are not related to the personal computer. In another variation of the invented identity recognition system several units in FIG. 1 may be modified so as to make them suitable for use in safes, houses, banking machines, different types of the military equipment, etc. The monitor/display unit 16 can be represented by any kind of simple crystal display or LED array display. The memory unit 18 can be represented by a hard code chip like the one used in modern answering machines, and the appropriate software version can be activated in these chips by the identity recognition system's manufacturers. Also in other variations of the invented identity recognition system used for universal banking/trading operations, the memory unit 18 can be excluded and all its functions can be fulfilled by remote server/data base linked to the aforementioned system through a network. The input device 10 can be represented by the panel with either touch sensitive sensors or rotated knobs or linear sliders moved in the slots. Time based elementary parameters of user password entry session symbols may include not only those ones that were mentioned above but such complementary parameters as T (password)—the period of time between user's entry of the first and last symbols of his/her password and other similar kinds of complementary parameters.

For the significant increase in the secure factor of the invented identity recognition system, there can be additional recommendation to use at least 9 or 10 symbols in the user's password. The system code can be entered by the user as an artistic/differentiation rhythm (like a melody). Thus the scope of this invention should be determined by the appended claims and their legal equivalents, rather than by the examples given.

What we claim is:

1. A method for identity recognition of an individual for enabling an access to a secured system based on a code input pattern, comprising the steps of:
providing said secured system with identification means for unabling access to said secured system for an unauthorized individual;
providing said identification means with an identification code that can be entered by said individual through said code input pattern, said code input pattern incorporating hidden characteristics which are invisible but uniquely inherent in said individual to the extent that they can be used for identification of said individual;
entering said identification code by said individual to said identification means;
measuring said hidden characteristics for obtaining code input pattern information;
providing said secured system with a reference input pattern information that enables access to said secured system;
comparing said code input pattern information with said reference input pattern information; and
enabling the access of said individual to said secured system if said code input pattern information coincides with said reference input pattern information.

2. The method of claim 1, wherein said step of entering said identification code comprising a movement performed by said individual.

3. The method of claim 1, wherein said input pattern information comprising at least one signal having a starting point and an ending point.

4. The method of claim 2, wherein said input pattern information comprising at least one signal having a starting point and an ending point.

5. The method of claim 4, wherein said movement is selected from the group consisting of rotation, linear movement, and pushing on at least one of signal entering members selected from a button, a pedal, a rotating knob, and a moveable linear slider.

6. The method of claim 1, wherein said input pattern information comprises a plurality of signals, each signal of said plurality having a starting point and an ending point.

7. The method of claim 6, wherein said step of measuring said hidden characteristics comprising registration of said starting point and of said ending point of each of said signals, calculation of a time interval between at least two signals of said plurality, and determining a statistical relationship between said at least two signals.

8. The method of claim 1, wherein said step of entering said identification code into said identification means is repeated with a plurality of entry sessions and with memorizing said hidden characteristics in each of said entry session for statistical determination of reference relationships between said hidden characteristics;
said step of enabling the access to said secured system taking place when said input pattern information coincides with said reference relationships.

9. The method of claim 8, wherein said identification means comprises a keyboard with a plurality of keys, said starting point and said ending point of each of said signals comprising a moment of pushing on each of said keys, which is pushed for said step for entering said identification code, and a moment of releasing said each of said keys, respectively.

10. The method of claim 5, wherein said step of entering said identification code into said identification means is repeated with a plurality of entry sessions and with memorizing said hidden characteristics in each of said entry session for statistical determination of reference relationships between said hidden characteristics; said step of enabling the access to said secured system taking place when said input pattern information coincides with said reference relationships.

11. The method of claim 10, wherein said identification means comprises a keyboard with a plurality of keys, said starting point and said ending point of each of said signals comprising a moment of pushing on each of said keys, which is pushed for said step for entering said identification code, and a moment of releasing said each of said keys, respectively.

12. The method of claim 1, wherein said reference input pattern information is presented in the form of a normal probability density distribution range for said identification code.

13. The method of claim 5, wherein said reference input pattern information is presented in the form of a normal probability density distribution range for said identification code.

14. The method of claim 7, wherein said reference input pattern information is presented in the form of a normal probability density distribution range for said identification code.

15. The method of claim 8, wherein said reference relationships are presented in the form of a normal probability density distribution range for said identification code.

16. A secure system for identity recognition of an individual for enabling an access to a secured system to an authorized individual and unabling said access to an unauthorized individual on the basis of a code input pattern, said system comprising:
at least one code input unit for inputting an identification code to said secure system, said identification code can be entered by said individual through said code input pattern and incorporates hidden characteristics which are invisible but uniquely inherent in said individual to the extent that they can be used for identification of said individual;
at least one memory unit for memorizing at least said identity code;
a processor connected to said at least one code input unit and said at least one memory unit for processing information obtained from said at least one code input unit and said memory unit;
a program that is stored in said at least one memory unit and provides the following steps under control of said processor:
entering said identification code by said individual to said secure system;
measuring said hidden characteristics for obtaining a code input pattern information
providing said secured system with a reference input pattern information that enables access to said secured system; comparing said code input pattern information with said reference input pattern information; and
enabling the access of said individual to said secured system if said code input pattern information coincides with said reference input pattern information.

17. The system of claim 16, wherein said step of entering said identification code comprises a movement performed by said individual.

18. The system of claim 16, wherein said input pattern information comprising at least one signal having a starting point and an ending point.

19. The system of claim 17, wherein said input pattern information comprising at least one signal having a starting point and an ending point.

20. The system of claim 19, wherein said movement is selected from the group consisting of rotation, linear movement, and pushing on at least one of signal entering members selected from a button and a pedal.

21. The system of claim 16, wherein said input pattern information comprises a plurality of signals, each signal of said plurality having a starting point and an ending point.

22. The system of claim 21, wherein said at least one code input unit comprises a keyboard with a plurality of keys, said starting point and said ending point of each of said signals comprising a moment of pushing on each of said keys, which is pushed for said step for entering said identification code, and a moment of releasing said each of said keys, respectively.

23. The system of claim 16, wherein said step of entering said identification code into said secure system is repeated with a plurality of entry sessions and with memorizing said hidden characteristics in each of said entry session for statistical determination of reference relationships between said hidden characteristics; said step of enabling the access to said secured system taking place when said input pattern information coincides with said reference relationships.

24. The system of 23, wherein said reference relationships are presented in the form of a normal probability density distribution range for said identification code.

25. The system of claim 22, wherein said step of entering said identification code into said secure system is repeated with a plurality of entry sessions and with memorizing said hidden characteristics in each of said entry session for statistical determination of reference relationships between said hidden characteristics; said step of enabling the access to said secured system taking place when said input pattern information coincides with said reference relationships.

26. The system of 25, wherein said reference relationships are presented in the form of a normal probability density distribution range for said identification code.
